(19) United States
(12) Patent Application Publication
(10) Pub. No.: US 2018/0249757 A1
(43) Pub. Date: Sep. 6, 2018

(54) SPHERICAL PRODUCT FORMATION IN A CONTINUOUS LIQUID ENROBER

(71) Applicant: Incredible Foods, Inc., Boston, MA (US)

(72) Inventor: Kristen Enright, Somerville, MA (US)

(21) Appl. No.: 15/907,753

(22) Filed: Feb. 28, 2018

Related U.S. Application Data
(60) Provisional application No. 62/465,315, filed on Mar. 1, 2017.

(51) Int. Cl. A23P 20/17; A23P 10/30; A23P 20/10; A23L 2/385

(52) U.S. Cl. CPC A23P 20/17; A23P 10/30; A23V 2002/00; A23L 2/385; A23P 20/105

(57) ABSTRACT

Edible payloads can be partially or fully polymerized by a system that receives the payloads into still liquid that prevents or restricts contact with other payloads, and controls an amount of time to achieve a desired degree of polymerization. An enrobing system can include a main fluid channel and a payload channel intersecting the main fluid channel Fluid can be directed from a fluid source coupled to the main fluid channel such that fluid flows upwardly into the payload channel to form a stagnant region of liquid. The payload can be directed through the stagnant liquid of the payload channel and through the flowing liquid of the main fluid channel

### TECHNICAL FIELD

This disclosure relates to processes and systems for enrobing an edible payload in a coating of edible materials, and more particularly to edible and/or biodegradable vessels. More particularly, this disclosure relates to a process and system for optimizing a spherical shape of an enrobed edible payload.

### BACKGROUND

As machines and systems for processing, transferring and handling edible materials are developed to achieve viable commercial production levels of a finished product, it is often desirable to optimize concomitantly a final product presentation (e.g., shape, size, etc). Soft foods may present certain challenges in that mechanical transfer and transport can damage the final product and/or processing intermediates. Therefore, processes and methods of manufacture for controlled and delicate handing of food products for optimizing final product structure are sought.

### SUMMARY

This disclosure describes processes and systems for enrobing material in an edible membrane. In many instances, it is desirable to form and maintain the material in a desired shape prior to and while coating the material with the membrane. Described herein are systems for and processes of enrobing a payload in a liquid by receiving a payload into still liquid, preventing contact with other payloads, and controlling chemical features of the liquid components to achieve a desired product shape.

Additional features and advantages of the subject technology will be set forth in the description below, and in part will be apparent from the description, or may be learned by practice of the subject technology. The advantages of the subject technology will be realized and attained as pointed out in the written description and embodiments hereof as well as the appended drawings.

In a certain embodiment, this disclosure describes a method for producing a substantially spherical soft food product containing a fluid inner core payload that is encapsulated by a polymer, wherein the fluid inner core payload is submerged into an encapsulating polymer solution to encapsulate the fluid inner core payload, the improvement comprising, providing a fluid inner core payload and an encapsulating polymer solution, wherein the density of the fluid inner core payload is about 1.05 to about 1.15 times the density of the encapsulating polymer solution.

In another embodiment, this disclosure describes a method for the production of a substantially spherical soft food product, comprising the steps of providing a fluid inner core payload and a fluid encapsulating polymer, wherein said fluid inner core payload density is about 1.05 to about 1.15 times the density of the fluid encapsulating polymer; and submerging the fluid inner core payload in the fluid encapsulating polymer, wherein submerging further comprises the fluid inner core traversing through the fluid encapsulating polymer a distance sufficient for the fluid inner core payload to achieve a substantially spherical form.

In another embodiment, this disclosure describes a method for producing a substantially spherical soft food product containing an inner core payload that is encapsulated by a polymer, comprising providing a fluid inner core payload and a payload channel containing an encapsulating polymer solution, wherein the density of the fluid inner core payload is about 1.05 to about 1.15 times the density of the encapsulating polymer solution; and adding the fluid inner core payload to the payload channel of encapsulating polymer solution, wherein the fluid inner core payload traverses the payload channel of encapsulating polymer, wherein the substantially spherical soft food product is produced.

In some aspects, any one or more of these methods are performed with the device as described herein. In some aspects, any one or more of these methods further comprise the step of polymerizing said fluid encapsulating polymer. In some aspects, in any one or more of these methods, the fluid inner core comprises cranberry juice or cranberry juice concentrate. In some aspects, in any one or more of these methods, the fluid inner core further comprises calcium. In some aspects, in any one or more of these methods, the encapsulating polymer comprises alginate.

It is to be understood that both the foregoing general description and the following detailed description are exemplary and explanatory and are intended to provide further explanation of the subject technology.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1A illustrates a plan view of an enrobing system for bathing a payload with a fluid, with a payload above a payload channel, according to certain aspects of the present disclosure.

FIG. 1B illustrates a plan view of an enrobing system for bathing a payload with a fluid, with a payload at an intersection of a payload channel and a main channel, according to certain aspects of the present disclosure.

FIG. 1C illustrates a plan view of an enrobing system for bathing a payload with a fluid, with a payload within a main channel, according to certain aspects of the present disclosure.

FIG. 1D illustrates a plan view of an enrobing system for bathing a payload with a fluid, with a payload beyond a main channel, according to certain aspects of the present disclosure.

FIG. 2A illustrates a view of a payload injection device, according to certain aspects of the present disclosure.

FIG. 2B illustrates a view of a receptacle, according to certain aspects of the present disclosure.

FIG. 2C illustrates a view of a receptacle and fluid bath, according to certain aspects of the present disclosure.

FIG. 3A illustrates a sectional view of a payload for enrobing with a fluid, according to certain aspects of the present disclosure.

FIG. 3B illustrates a sectional view of a payload within a first fluid, according to certain aspects of the present disclosure.

FIG. 3C illustrates a sectional view of a payload enrobed with a first fluid, according to certain aspects of the present disclosure.

FIG. 3D illustrates a sectional view of a payload enrobed with a first fluid and within a second fluid, according to certain aspects of the present disclosure.

### DETAILED DESCRIPTION

In the following detailed description, numerous specific details are set forth to provide a full understanding of the present disclosure. It will be apparent, however, to one ordinarily skilled in the art that embodiments of the present disclosure may be practiced without some of the specific details. In other instances, well-known systems and techniques have not been shown in detail so as not to obscure the disclosure. In the referenced drawings, like numbered elements are the same or essentially similar. Reference numbers may have letter suffixes appended to indicate separate instances of a common element while being referred to generically by the same number without a suffix letter.

While the discussion herein is provided primarily in the context of encapsulating food product within a membrane, the disclosed concepts and methods may be applied to other fields that would also benefit from the principles discussed herein. For example, other materials may be used with the systems and methods described herein to produce products coated in a membrane.

As used herein, the term “payload” is meant to have its plain and ordinary meaning, which includes, without limitation, the material that is coated or treated with liquid in the system. In some instances, the payload is molded and then coated, and in some instances, the payload is a liquid. By way of example only, the payload may refer to a liquid that is coated or that interacts with other liquids in the system to polymerize part or all of the payload liquid. Additionally, the payload may be a molded sphere of ice cream or yogurt that is coated by the processes described herein.

As used herein, “channel” may refer to any structure sufficient to contain an aqueous solution, including, but not limited to, a trough, reservoir, pipe, bath, cistern, container, etc., as may be used in the processing of the payload.

This disclosure relates to methods and systems for enrobing an edible payload in a coating of edible materials, which may be solids or liquids. Systems and methods of the present disclosure allow a payload to be enrobed with a coating or polymerized part of, or throughout, the payload while preventing or reducing distortion of the payload shape. Systems and methods of the present disclosure allow a payload to be enrobed with a coating or polymerized part of, or throughout, the payload developing and maintaining approximately spherical formation. Systems and methods of the present disclosure allow a payload to be enrobed with a coating or polymerized part of, or throughout, the payload by receiving the payload into still or nearly still liquid. Systems and methods of the present disclosure allow a payload or coating to polymerize without coming into contact with other payloads until they reach a destination. Systems and methods of the present disclosure allow a payload to be enrobed for a programmable amount of time to achieve a desired skin strength and thickness.

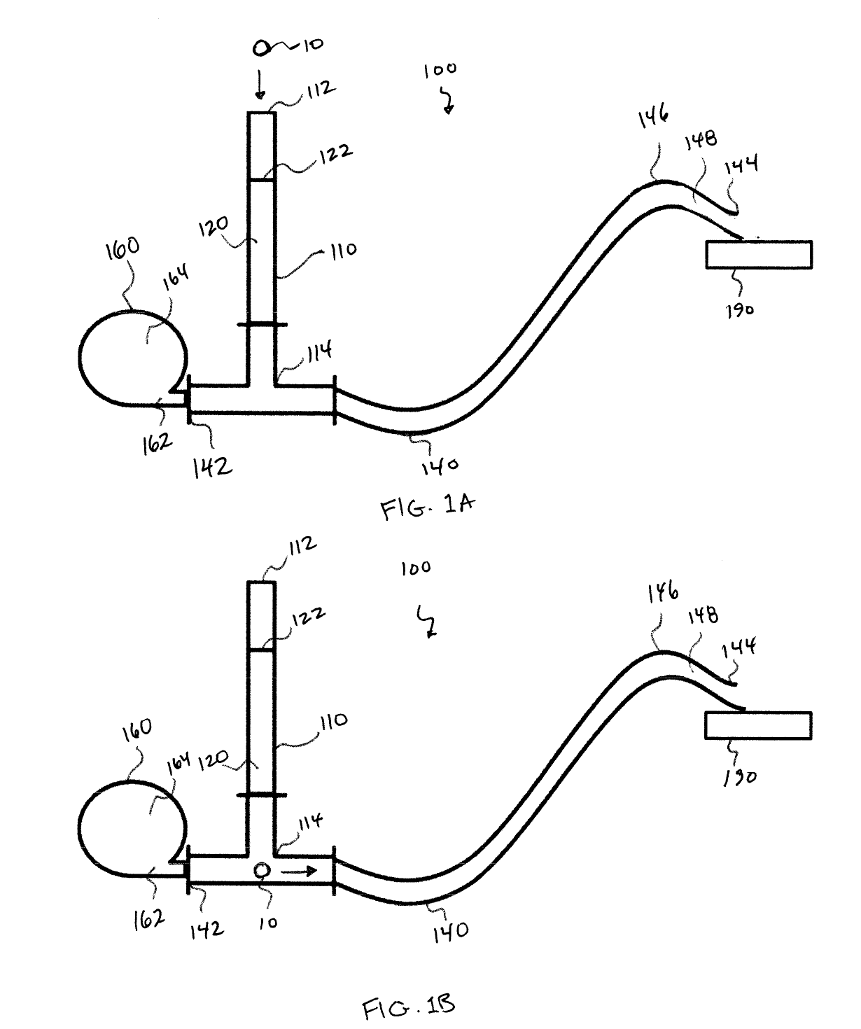

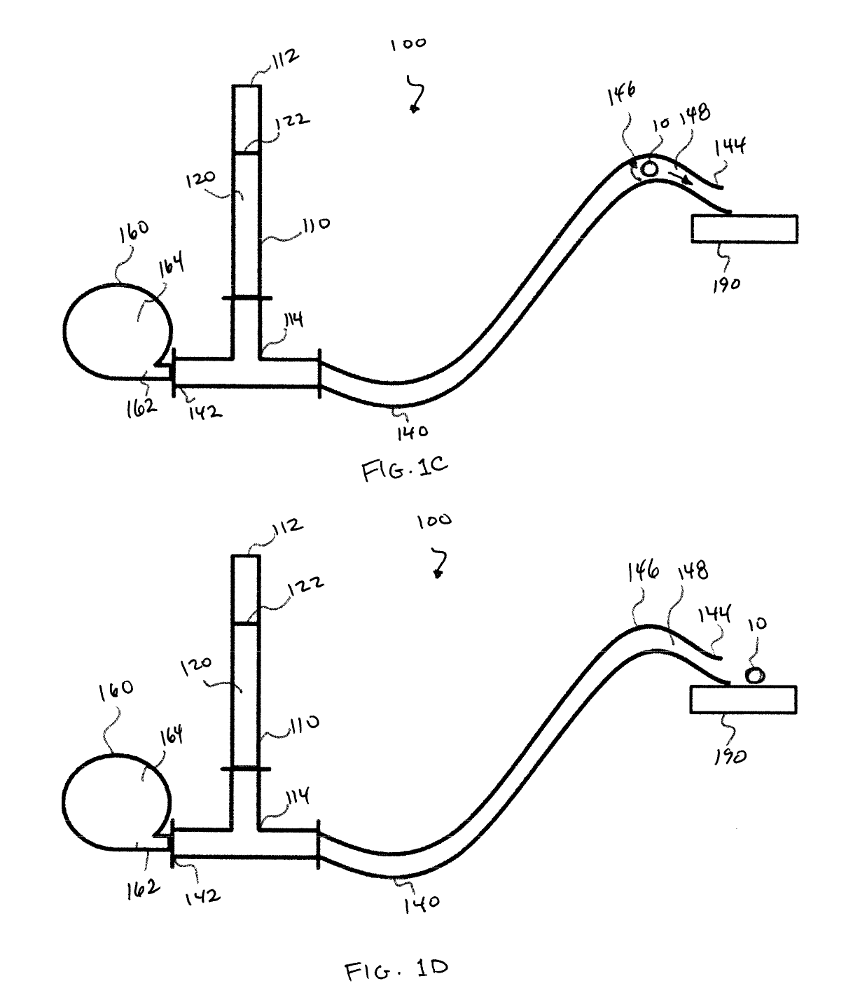

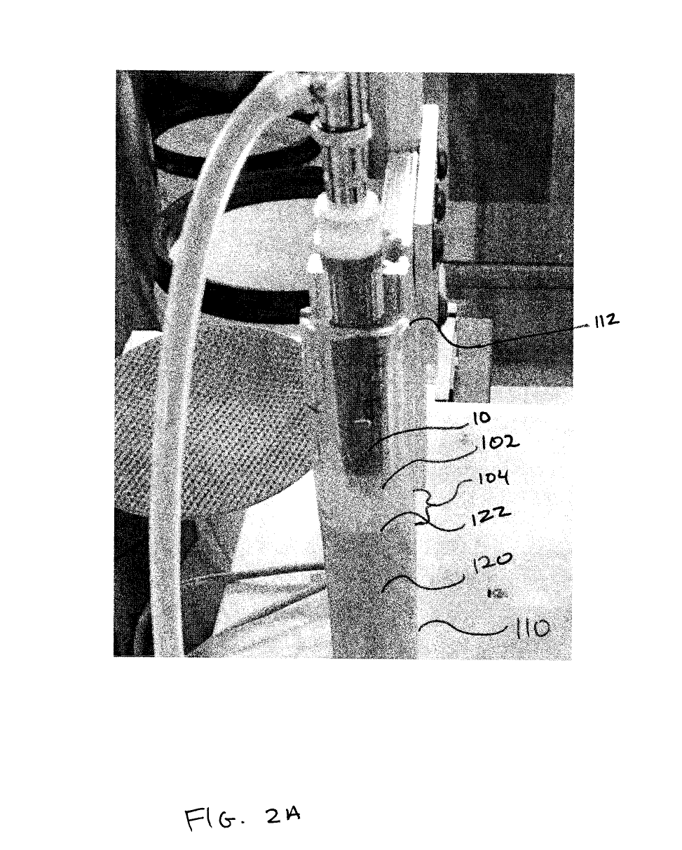

FIG. 1A illustrates a schematic plan view of an enrobing system 100 for bathing a payload 10 with a fluid 120, with the payload 10 above a payload channel 110, according to certain aspects of the present disclosure. According to one or more embodiments, as shown in FIG. 1A, an enrobing system 100 is provided for bathing a payload 10 with a fluid 120. The enrobing system 100 includes a main fluid channel 140 and a payload channel 110. The payload channel 110 and the main channel 140 can each form a tube along at least a portion of a length thereof. The tube can be circumferentially closed to maintain pressure and flow conditions as well as to protect the payload 10 from environmental exposure. The main fluid channel 140 includes an inlet 142 and an outlet 144, opposite the inlet 142. The payload channel 110 includes a first end 112 that permits fluid communication between the payload channel 110 and ambient air. A second end 114 is fluidly coupled to the main fluid channel 140 between the inlet 142 and the outlet 144.

According to one or more embodiments, the payload channel 110 can be oriented to intersect the main channel 140. For example, the payload channel 110 can be oriented orthogonally relative to the main channel 140. By further example, the payload channel 110 can be oriented transversely (including non-orthogonally) relative to the main channel 140. For a given height (e.g., vertical elevation), the length and angle of intersection can be modified to achieved a desired height of the liquid within the payload channel 110 through which the payload 10 must travel. The payload channel 110 can be straight and/or arcuate along at least a portion of its length. For example, the payload channel 110 can provide an arcuate or ramped portion that gradually transitions from a flow direction within the payload channel 110 to a flow direction within the main channel 140.

The payload channel 110 can extend upward from the main fluid channel 140, such that the fluid 120 is drawn downwardly within the payload channel 110 toward the main fluid channel 140. According to one or more embodiments, more than one payload channel 110 can be provided in fluid communication with the main channel 140. A plurality of payload channels 110 can be provided at the same or different orientations relative to the main channel 140. A plurality of payload channels 110 can intersect the main channel 140 at the same or different locations along the length of the main channel 140.

According to one or more embodiments, as shown in FIG. 1A, a fluid source 160 is coupled to the main fluid channel 140 at the inlet 142. The fluid source 160 is configured to conduct fluid 120 into the main fluid channel 140 such that fluid 120 flows from the inlet 142 toward the outlet 144. The fluid source 160 provides a pressure of the fluid 120 through the main fluid channel 140 such that fluid 120 is conducted upwardly into the payload channel 110 between the first end 112 and the second end 114 of the payload channel 110.

According to one or more embodiments, as shown in FIG. 1A, the payload channel 110 is configured to receive a payload 10 through the first end 112 and conduct the payload 10 from the first end 112 to the second end 114. The payload channel 110 includes a length, and, during use, the fluid 120 resides within the payload channel 110 a portion of the length sufficient for the payload 10 to require a predetermined amount of time to travel from the first end 112 to the second end 114. For example, as shown in FIG. 1A, a surface 122 of the fluid 120 is formed within the first end 112 and the second end 114. A length of fluid 120 within the payload channel 110 is defined by the distance from the surface 122 to the second end 114. According to one or more embodiments, the surface 122 is formed at the first end 112.

According to one or more embodiments, the predetermined amount of time within the payload channel 110 is sufficient for the payload 10 to interact with the fluid 120 such that the fluid 120 interacts with the payload 10 to cause polymerization of at least a portion of the payload 10 or the fluid 120 contacting the payload 10. The polymerization may result in formation of a membrane or shell about the payload 10. In some instances, the predetermined amount of time is sufficient for substantially the entire payload 10 to be polymerized. The fluid 120 includes a density such that the payload 10 travels the length in a predetermined amount of time. According to one or more embodiments, the predetermined amount of time is about 30 seconds. Other amounts of time are contemplated based on a desired degree of polymerization and the selection of payload 10 and fluid 120. For example, the predetermined amount of time can be 5 seconds, 10 seconds, 15 seconds, 20 seconds, 25 seconds, 30 seconds, 35 seconds, 40 seconds, 45 seconds, 50 seconds, 55 seconds, 60 seconds, or greater than 60 seconds.

According to one or more embodiments, during operation, the fluid source 160 can provide the fluid to the inlet 142 and cause a flow of fluid within the main channel 140. As shown in FIG. 1A, the main channel 140 can have a peak 146 between the inlet 142 in the outlet 144. More particularly, as shown in FIG. 1A, the peak 146 can be between the second end 114 of the payload channel 110 and the outlet 144 of the main channel 140. The peak 146 can form at an elevation that is higher than the intersection of the payload channel 110 and the main channel 140. The peak 146 can also form and an elevation that is higher than the outlet 144 of the main channel 140. Accordingly, a pressure can be required to cause the fluid 122 rise to the peak 146 before it arrives at the outlet 144. This pressure can be provided by the fluid source 160.

Pressure within the main channel 140 also causes at least a portion of the payload channel 110 to fill with the fluid 120. The level of the surface 122 can be determined by the pressure provided by the fluid source 160. The pressure can be sufficient to allow flow of the fluid 122 to the peak 146 and the outlet 144 and simultaneously determine the elevation of the surface 122 of the fluid 120 within the payload channel 110. At the peak 146, the pressure can be equal to atmospheric pressure or greater than atmospheric pressure. After a balance of pressures exist between the main fluid channel 140 and the payload channel 110, the payload channel 110 is configured such that fluid 120 within the payload channel 110 remains substantially stagnant while fluid 120 flows through the main fluid channel 140.

According to one or more embodiments, the pressure of the fluid 120 can be sufficient to force the fluid 120 out of the first end 112 of the payload channel 110. In such operation, the payload channel 110 receives an upward flow of fluid 120 therein from the main fluid channel 140 to replenish fluid 120 conducted out of the payload channel 110. The upward flow can be slow enough to allow a payload 10 to descend from the first end 112 to the second end 114 of the payload channel 110. According to one or more embodiments, additional fluid sources (not shown) can be provided at one or more locations along the payload channel 110 to provide additional fluid 122 within the payload channel 110.

According to one or more embodiments, the fluid source 160 includes a pump 162 that pumps the fluid 120 into the main fluid channel 140. According to one or more embodiments, the fluid source 160 includes a fluid reservoir 164 or a regulated manifold that directs the fluid 120 into the main fluid channel 140. Various controls and/or flow regulation devices can be provided to allow programming and control of pressure and flow rate generated by operation of the fluid source 160. Sensors and monitoring devices can be provided to measure performance of the fluid source 160 and, optionally, provide a feedback mechanism to regulate operation of the fluid source 160.

According to one or more embodiments, a distal flow channel 148 is fluidly coupled to the outlet 144 of the main fluid channel 140. The distal flow channel 148 can define a path sloping upwardly. A height of the upwardly sloping path (e.g., at the peak 146) contributes to a level to which the fluid 120 is conducted upward into the payload channel 110 between the first and second ends 112, 114. The distal flow channel 148 can form a pathway that is linear, arcuate, helical, etc., while achieving a height at the peak 146 that promotes the desired height of the surface 122 within the payload channel 110.

The upward sloping path includes a distal end from which the payload 10 is discharged from the system 100. A distal flow channel 148 fluidly coupled to the outlet 144 of the main fluid channel 140, the distal flow channel 148 defining an elongate path. A length and height of the elongate path determines a back pressure within the main fluid channel 140 that determines a level to which the fluid 120 is conducted upward into the payload channel 110 (e.g., at surface 122) between the first and second ends 112, 114. The elongate path includes a distal end from which the payload 10 is discharged from the system 100.

From the outlet 144, the payloads 10 may be provided to a receptacle 190. The receptacle 190 can include a fluid bath, a cage, a processing unit, or a conveyance device. The receptacle 190 can include drainage and filtering to separate the payload 10 from the fluid 120 after both the payload 10 and the fluid 120 exit the outlet 144.

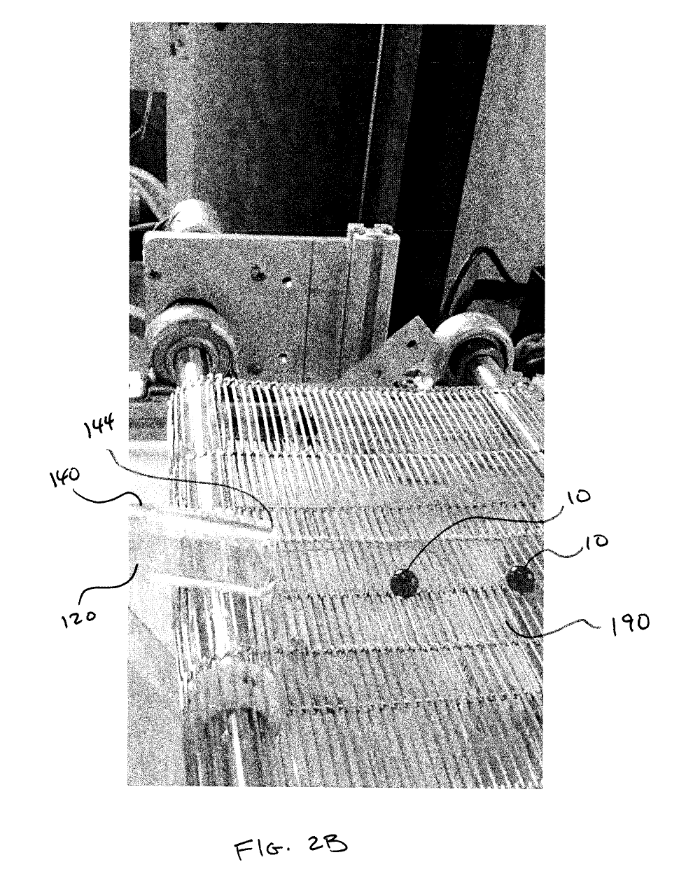

FIG. 2A illustrates a view of a payload injection device 102, according to certain aspects of the present disclosure. According to one or more embodiments, as shown in FIG. 2A, the injection device 102 can be provided at or near the first end 112 of the payload channel 110. The material for the payloads 10 can be provided within the injection device 102 for extrusion or release at an end of the injection device 102 opposite the surface 122 of the fluid 120. According to one or more embodiments, a gap 104 can be formed between a terminal end of the injection device 102 and the surface 122, such that a payload 10 released from the injection device 102 can pass through the gap 104 before arriving at the surface 122 of the fluid 120. The height of the gap 104 can be selected such that, during passage of the payload 10 through the gap 104, the payload 10 forms a substantially spherical shape before and as the payload 10 contacts the surface 122. For example, the gap 104 can be approximately 1 cm. In some embodiments, the gap 104 is between about 1 cm and about 3 cm, and in some embodiments, the gap 104 is greater than about 3 cm. The gap 104 can be selected based on the size and/or viscosity of the material used to form the payloads 10 and the viscosity of the fluid 120 into which the payload 10 is injected, to facilitate formation and maintenance of substantially spherical shapes.

The viscosity of the payload 10 can be great enough to prevent dispersion of the payload 10 into the fluid 120 upon contact therewith. The viscosity of the fluid 120 can be low enough to prevent or limit damage to the payload 10 and high enough to regulate the speed and passage of the payload 10 through the payload channel 110. According to one or more embodiments, an inner diameter of the payload channel 110 can be selected to be greater than an outer diameter of the payload 10, such that the payload 10 can be entirely surrounded by the fluid 120 and be allowed to pass through the payload channel 110 without contacting the walls of the payload channel 110.

FIG. 2B illustrates a view of a receptacle 190, according to certain aspects of the present disclosure. According to one or more embodiments, as shown in FIG. 2B, the receptacle 190 can be a conveyance device that supports one or more payloads 10 that are deposited thereon. The receptacle 190 can allow a substantial portion of the payloads 10 to be covered in a layer of the fluid 120 while allowing an excess amount of the fluid 120 to be removed from the payloads 10.

FIG. 2C illustrates a view of a receptacle and fluid bath, according to certain aspects of the present disclosure. According to one or more embodiments, as shown in FIG. 2C, the receptacle 190 can be configured to continuously or intermittently transport the payloads 10 to a fluid bath 200. The fluid bath 200 can contain a second fluid 230. The second fluid 230 can be different from the fluid 120 of the payload channel 110 and the main channel 140, as described further herein.

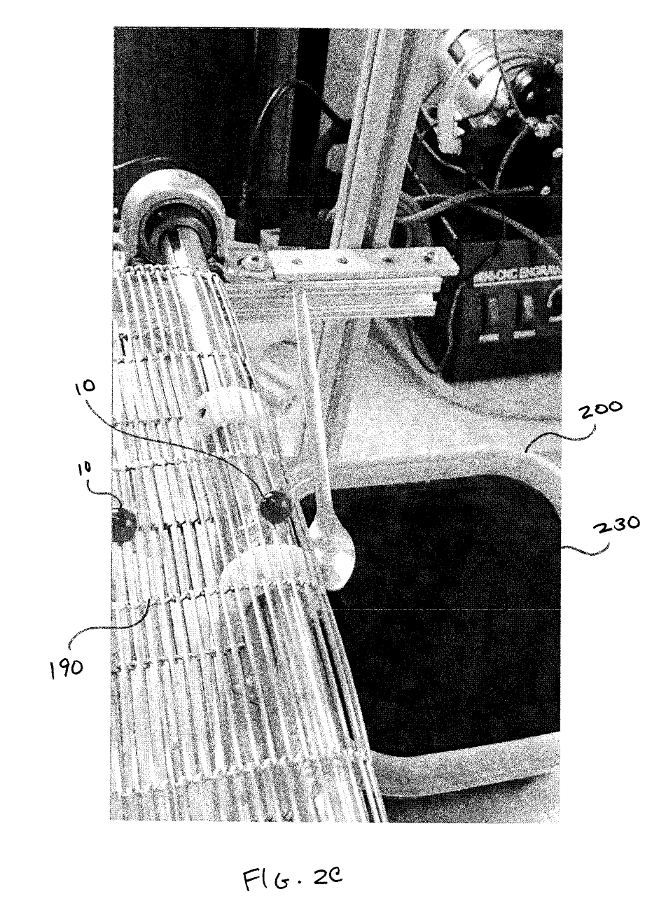

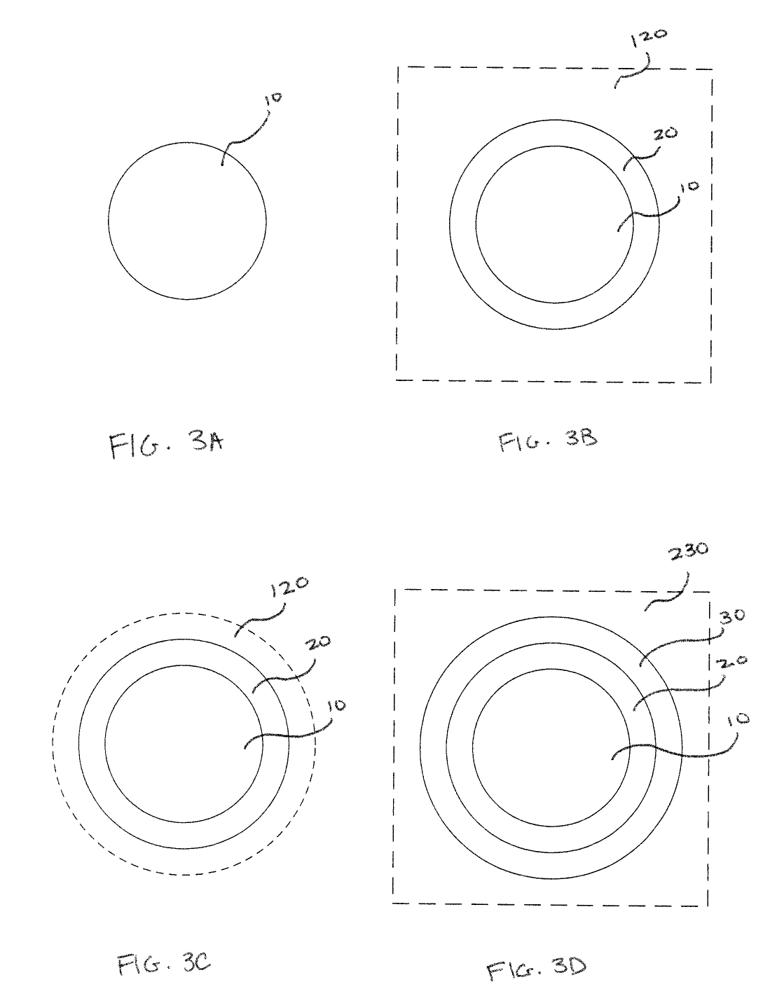

FIG. 3A illustrates a sectional view of a payload for enrobing with a fluid, according to certain aspects of the present disclosure. According to one or more embodiments, as shown in FIG. 3A, a payload 10 can be formed of a first material. The first material can include a substance that is configured to chemically react with the first fluid 120. For example, the payload 10 can include divalent cations (e.g., calcium) or anions (e.g., alginate).

FIG. 3B illustrates a sectional view of a payload within a first fluid, according to certain aspects of the present disclosure. According to one or more embodiments, as shown in FIG. 3B, the payload 10 can be submerged within the first fluid 120. As discussed further herein, the payload 10 can be submerged within the first fluid 120 while within the payload channel 110 and/or the main channel 140. The first fluid 120 can include a substance that is different from and configured to react with a substance of the payload 10. For example, where the payload 10 includes cations (e.g., calcium), the first fluid 120 can include anions (e.g., alginate). Where the payload 10 includes anions (e.g., alginate), the first fluid 120 can include cations (e.g., calcium). The exposure of the payload 10 to the first fluid 120 can facilitate polymerization to form a first shell 20 about at least a portion of the payload 10.

FIG. 3C illustrates a sectional view of a payload enrobed with a first fluid, according to certain aspects of the present disclosure. According to one or more embodiments, as shown in FIG. 3C, after the payload 10 exits the main channel 140 and is deposited on the receptacle 190, an excess amount of first fluid 120 is removed and at least a portion of the payload 10 and the first shell 20 remains covered in a coating of the first fluid 120.

FIG. 3D illustrates a sectional view of a payload enrobed with a first fluid and within a second fluid, according to certain aspects of the present disclosure. According to one or more embodiments, as shown in FIG. 3D, the payload 10 can be submerged within the second fluid 230 of the fluid bath 200. The second fluid 230 can include a substance that is different from and configured to react with a substance of the first fluid 120. For example, where the fluid 120 includes cations (e.g., calcium), the second fluid 230 can include anions (e.g., alginate). Where the first fluid 120 includes anions (e.g., alginate), the second fluid 230 can include cations (e.g., calcium). The exposure of the first fluid 120 to the second fluid 230 can facilitate polymerization to form a second shell 30 about at least a portion of the first shell 20. In some instances the first shell 20 and the second shell 30 are conjoined, or become one shell, during the processes of polymerization, to form a surface or shell around the payload that has a significantly greater hardness than the material of the payload within the shell.

The edible membranes/shells of enrobing systems can be formed from various substances allowing different compositions to be enrobed and consumed. According to one or more embodiments, the fluid 120 includes alginate. According to one or more embodiments, the fluid 120 includes calcium. According to one or more embodiments, the payload 10 includes calcium. For example, the payload could include calcium such that it interacts with alginate in the fluid to polymerize all or part of the payload without requiring an alginate-coated payload to be treated with a calcium bath. In these instances, the calcium-rich payload may interact directly with the fluid of the system. According to one or more embodiments, the payload 10 includes alginate. For example, the payload could include alginate such that it interacts with calcium in the fluid of the system to polymerize all or part of the payload without requiring an alginate-rich payload to be treated with a calcium bath. In these instances, the alginate-rich payload may interact directly with the calcium-rich fluid of the system. According to one or more embodiments, the payload 10 is a liquid.

As used herein, the terms “membrane(s),” “matrix” or “matrices,” and “shell(s)” may refer to similar or different materials or kinds of materials, depending on the type of object, how many barrier layers of any sort it may have, or the properties and contents of any such barrier layers. Thus, for some embodiments, the terms can be used interchangeably. In certain embodiments, membranes and/or membranes and shells are edible, providing nutritious benefits as well as reducing concerns about littering and waste. Embodiments of transport systems described herein can have, e.g., varying shell or membrane thickness, one or more of a variety of chemical constituents, varying numbers of membranes, various consumable payloads, various shapes, and are constructed from various shell/membrane properties to provide a variety of flavors and textures and membrane characteristics. Embodiments of the transport systems can be made at large scale, using, for example, injection techniques, spray and spray drying techniques, fluidized-bed and other technologies. See, for example, PCT application WO 2011/103594, hereby incorporated in its entirety.

Edible materials are generally solid, semi-solid or liquid in form, are capable of providing nutrition when consumed, and are typically provided in a form suitable for ingestion. Edible materials can be derived from many sources including plants and animals, particularly those generated by agriculture, or from artificial production methods including chemical synthesis. Edible refers to any substance that can provide for an organism's (e.g., a human or other mammal) nutritional needs or sensory desires, typically when consumed orally, and is usually non-toxic when properly consumed. Biodegradable refers to capable of being decomposed by actions of biological agents such as microorganisms, or by non-biological effects such as environmental exposure. Liquid refers to having a consistency like that of water or oil, that is to say, flowing freely but of substantially constant volume. Solid refers to being characterized by structural rigidity and resistance to changes of shape and volume. Semi-solid refers to having a rigidity intermediate between a solid and a liquid. Viscosity refers to a fluid's resistance to flow, wherein gel-like liquids have higher viscosity—for example, honey is more viscous than water. Foam refers to a mass of small bubbles formed on or in a substrate, typically a liquid, but also includes ice cream, frozen yogurts and gellato. Frozen refers to a phase change in which a liquid is turned into a solid when its temperature is lowered beyond its freezing point. In some embodiments, the food material may be liquid, partially liquid, viscous, partially or fully solid, or contains several states of matter having different degrees of liquidity or solidness.

Ingestible substances include those that are edible or potable such as, for example, juice, chocolate, various medicines, and various other solids, liquids, slurries, emulsions, foams, etc. For example, foods, particularly fruits and vegetables, such as berries, plants, and beans, are provided in various states of matter: liquid, semi-solid, solid, and frozen. They can be mixed with each other and optionally one or more nutrients and additives in varying proportions can be added to the mixture to produce a large variety of novel food objects. Their texture and consistency can be manipulated by physical, chemical or biochemical means.

Membranes and shells of transport systems may be made by using any one of many edible and/or biodegradable polymers. Alginate (alginic acid) is an example of a polymer used for forming a membrane of transport system for a payload. Alginate is an anionic, polymeric polysaccharide, widely present in the cell walls of brown algae. It is a copolymer -(M)m-(G)n- segments composed of mannuronate M (manurronic acid) and guluronate G (guluronic acid) monomeric subunits. The values of m and n, the ratio m/n, and the space distribution between M and G (i.e. presence of consecutive G-subunits and M-subunits, or randomly organized subunits) all play key roles in the chemical and physical properties of the final membrane.

Alginates have been applied to pharmaceutical preparations, impression-making materials (e.g., in dentistry and in prosthetics manufacturing), and in the food industry. Sodium alginates also have found application in restaurants, e.g., to create spheres of liquid surrounded by a thin jelly membrane. Modern chefs such as Faran Adria have used sodium alginates to create “melon caviar,” “false fish eggs,” etc., by adding sodium alginates into a liquid (e.g., melon juice), then dropping the preparation in a calcium bath (calcium lactate or calcium chloride). Beyond their biocompatibility to human use, polymers such as alginate have the capacity to easily form a gel. To induce rapid gelation by electrostatic cross-linking, the naturally present Na+ ions are removed and replaced by divalent cations (e.g., Ca2+ or another multi-valent cation such as Mg2+).

One approach involves forming encapsulated vessels (transport systems) that use various particles, particulates and polymers, in combination or separately, to create desired properties of strength, stability, permeability, edibility and biodegradability for the transport systems to be easily moved and consumed. As used herein, the terms particle(s) and particulate(s) are used interchangeably.

In some embodiments, the edible or potable substance can be coated in a plurality of membranes. In certain embodiments, the membrane layers are distinct and melded. In other embodiments, the membrane layers are separate and distinct from other membrane layers. In certain embodiments, the same polymer, particulate, or combination of polymer(s) and/or particulate(s) is used for each of the multi-membrane coatings as described herein. In certain embodiments, different polymers, particulates, or combination of polymer(s) and/or particulate(s) are used for each membrane in a multi-membrane layer. In some embodiments, a multilayered outer membrane has the same polymer, particulate, or combination of polymer(s) and/or particulate(s) in each of the outer layers, but the membrane components are different than that used in, for example, the inner membrane or other inner membrane layers.

To accomplish the use of the same membrane components in a multi-membrane layered system while keeping the layers separate and distinct, in some embodiments, the inner membrane is first constructed, with or without additional particulates and/or polymers incorporated into the inner membrane. The membrane-coated substance can then be layered with one or more additional polymer/particulate layers of homogenous or heterogenous polymer/particulates, and then the particulate layer can be coated again with another membrane. The process may be repeated as many times as desired to construct a multilayered product.

Various membrane polymers are contemplated for use in the membrane forming layers. Considerations for choice of membrane polymers include inherent physico-chemical characteristics (charge states, functional groups, kinetic reaction rates of polymerization, ion complex formation and cross-linking, etc.), texture, polymerization characteristics, reactivity to chemical interactions and reactions such as pH, ionic strength, specific ions and ratios of ions during polymerization, presence of complexing agents (e.g., phosphates, citrate, ethylenediaminetetraacetic (EDTA) acid, acids, glucono-delta-lactone (GDL), etc.), shielding susceptability of electrostatic character of polymer and polymeric strands, and cost effectiveness if used for commercial production. Polysaccharide polymers contemplated herein include, but are not limited to, shellac, various fibers and hydrocolloids such as alginate, an agar, a starch, a gelatin, carrageenan, xanthum gum, gellan gum, galactomannan, gum arabic, a pectin, a milk protein, a cellulosic, gum tragacanth and karaya, xyloglucan, curdlan, a cereal β-glucan, soluble soybean polysaccharide, a bacterial cellulose, a microcrystalline cellulose, chitosan, inulin, an emulsifying polymer, konjac mannan/konjac glucomannan, a seed gum, and pullulan. Combinations of these polysaccharides are also contemplated herein.

Other membrane compounds considered for use as structure-forming compounds to modify or be used in combination with a polymer-based membrane (for example, a membrane consisting of a polysaccharide) include bagasse, tapioca, chitosan, polylactic acid, processed seaweed, chocolate, starch, gum arabic, cellulose based fibers, natural and synthetic amino acids and polymers thereof, proteins and sugars/sugar derivatives. Combinations of these compounds and compositions are also contemplated herein.

In some embodiments, a consumable, edible product is encased in a polysaccharide membrane, for example, an alginate membrane. Methods for encasing a consumable edible product are found in PCT Publication WO/2013/113027, published on Aug. 1, 2013, the entire contents of which are incorporated by reference, as if fully set forth herein.

A method of enrobing a payload, according to one or more embodiments, is described herein. According to one or more embodiments, as shown in FIG. 1A, the fluid 120 can be directed from the fluid source 160 to the inlet 142 into the main fluid channel 140 such that the fluid 120 flows from the inlet 142 toward the outlet 144 and upward into the payload channel 110 between the first and second ends 112, 114. The payload channel 110 and the main channel 140 can be filled with the fluid 120 before any payload 10 is provided to the system 100 and until the level of the fluid 120 within the payload channel 110 reaches equilibrium.

According to one or more embodiments, the fluid 120 is directed upwardly into the payload channel 110 to a height sufficient for the payload 10 to require a predetermined amount of time to travel from the first end 112 to the second end 114. Conducting fluid 120 through the main fluid channel 140 balances pressure between the main fluid channel 140 and the payload channel 110, such that fluid 120 within the payload channel 110 remains substantially stagnant while fluid 120 flows through the main fluid channel 140.

The flow through the main channel 140 can be continuous and/or constant during operation. At the surface 122 of the fluid 120, the fluid 120 can have little or no flow velocity or turbulence. The stillness of the liquid 120 at the surface 122 can prevent or reduce distortion of the payload shape upon introduction to the fluid 120. A constant flow of fluid 120 can be provided within the payload channel 110 from the main fluid channel 140 to replenish fluid 120 that is conducted out of the payload channel 110. Additionally, fluid 120 can be provided directly to the payload channel 110 at one or more locations between the first and second ends 112, 114.

According to one or more embodiments, the payload 10 can be provided to the payload channel 110 by one or more of a variety of means. For example, the payload 10 can be provided to the inlet 112 of the payload channel 110 by an injector, a conveyance device, or a fluid flow. As the payload 10 is conducted through the payload channel 110, the payload 10 can progressively form an increasingly symmetrical sphere.

FIG. 1B illustrates a plan view of the enrobing system 100 for bathing the payload 10 with the fluid 120, with the payload 10 at an intersection of the payload channel 110 and the main channel 140, according to certain aspects of the present disclosure. According to one or more embodiments, as shown in FIG. 1B, the payload 10 can be directed through the first end 112. The payload 10 is conducted from the first end 112 to the second end 114. The predetermined amount of time required for the payload tend to be conducted from the first end 112 for the second end 114 is sufficient for the payload 10 to interact with the fluid 120 such that the fluid 120 interacts with the payload 10 to cause polymerization of at least a portion of the payload 10 or the fluid 120 contacting the payload 10. For example, the predetermined amount of time can be sufficient for substantially the entire, or substantially all of, payload 10 to be polymerized. The predetermined amount of time can be determined as set forth herein, such that allowing the payload time to be conducted through the payload channel 110 is sufficient to cause a desired degree of polymerization.

FIG. 1C illustrates a plan view of the enrobing system 100 for bathing the payload 10 with the fluid 120, with the payload 10 within the main channel 140, according to certain aspects of the present disclosure. According to one or more embodiments, as shown in FIG. 1C, the fluid 120 and the payload 10 can be conducted through a distal flow channel 148 fluidly coupled to the outlet 144 of the main fluid channel 140. The payload 10 can travel along the distal flow channel 148 as it defines an upwardly sloping path that passes through the peak 146. Time spent within the main channel 140 by the payload 10 can further polymerize at least a portion of the payload 10. According to one or more embodiments, the main channel 140 has an inner cross-sectional dimension to allow the payload tend to roll or tumble within the main channel 140 as it is driven by the flow of the fluid 120. A rolling or tumbling motion of the payload 10 can help the payload 10 form and maintain a substantially spherical shape.

According to one or more embodiments, the amount of time spent within the payload channel 110 can be substantially greater than the amount of time spent within the main channel 140 due to the flow rate of the fluid 120 through the main channel 140. For example, in some embodiments, the time the payload spends in the payload channel 110 is twice the time the payload spends in the main channel 140. In some embodiments, the time the payload spends in the payload channel 110 is three times the time the payload spends in the main channel 140. In some embodiments, the time the payload spends in the payload channel 110 is about the same time the payload spends in the main channel 140. In some embodiments, the time the payload spends in the payload channel 110 is less than (e.g., half or one-quarter) the time the payload spends in the main channel 140.

FIG. 1D illustrates a plan view of the enrobing system 100 for bathing the payload 10 with the fluid 120, with the payload 10 beyond the main channel 140, according to certain aspects of the present disclosure. According to one or more embodiments, as shown in FIG. 1D, the fluid 120 and the payload 10 can be discharged from a distal end of the upward sloping path at the outlet 144. Upon exiting the outlet 144, the payload 10 can be deposited upon or within a receptacle 190. At the receptacle 190, the fluid 120 can be separated from the payload 10.

According to one or more embodiments, a plurality of payloads 10 can be provided to the enrobing system 100 in successive intervals. Each payload 10 can be provided after a given amount of time since a previous payload 10 was provided to the enrobing system 100. After a first payload 10 has been provided to the enrobing system 100, a second payload 10 can be provided before the first payload 10 has exited the outlet 144 and arrived at the receptacle 190. At any given moment in time, a plurality of payloads 10 can be conducted through the enrobing system 100 while maintaining a given distance between each adjacent payload 10, to prevent direct contact with each other.

Manufacturing processes for encapsulated edible products made with the machine and system described herein can be optimized by incorporating chemical components with properties yielding desirable qualities in a final product (encapsulating membrane strength, uniformity of encapsulating membrane thickness, final overall shape of the encapsulated product, consistency in final overall shape and size, etc.). Consideration can be drawn to, for example, chemical-physical properties of the liquid material to be encapsulated, i.e. the payload core (10), and the encapsulating membrane matrix fluid (120). Specifically, properties such as relative and absolute densities and/or viscosities of the chemical components used in the system may influence desirable qualities of the final product.

The density of the core material relative to the encapsulating membrane matrix fluid can be important for the extent of spherical shape and /or size formation. For example, the density of the core material can impact the rate at which the payload (10) falls through the fluid encapsulating membrane matrix surface (120) into the payload channel (110). An engineered payload core density relative to the encapsulating matrix (120), for example, can result in the control of the rate at which surface tension in the encapsulating membrane matrix fluid (120) is overcome.

Additionally, conditions for the fluid encapsulating membrane matrix and payload core components include temperature variation, which affects component density and/or viscosity. Density of the component materials also can be affected through the temperature effect on gasses present in the materials. Whether by direct effect on the materials or the gasses dissolved therein, cooler temperatures of the payload core relative to the encapsulating membrane matrix fluid can be correlated to higher relative density of the payload core to the encapsulating matrix, resulting in alteration of the initial translation rate into and through the payload channel In some embodiments, a temperature differential between the payload core and the encapsulating matrix can be adjusted during the polymerization process, contributing to different temporally variable physical properties of the payload core. Temporal temperature differences in the payload core and/or the encapsulating matrix therefore may affect buoyancy properties of the product during the manufacturing process, with such buoyancy differences being utilized to optimize the production process.

Because the force of translating the core material through the payload channel (110) is due primarily to gravity, small differences in the densities of the core material (10) and/or the encapsulating membrane matrix fluid (120) relative to each other in the payload channel (110) can affect the rate at which the payload channel is translated by the payload (10), further influencing the final product shape and/or size. Densities of the core material payload (10) that are too high relative to the encapsulating membrane matrix fluid (120) can fall through the payload channel (110) at a higher than desirable velocity for a sphere to form. These higher density core material payloads tend to form a “teardrop” shape, wherein the tails of the teardrop shape that form may contribute to a weak(er) spot in the encapsulating membrane matrix as well as not have the desired spherical shape in the final product. When the density of the core material payload (10) is too low relative to the encapsulating membrane matrix fluid (120), the lower density core material payload tends to form a tear drop shape with a flattened leading face. The flattened face results from an initial delay in falling through the surface (122) of the fluid (120), during which the polymerization process begins with the encapsulating membrane matrix fluid on the flattened front face and preventing the formation of a spherical shape. Because the side opposite of the flattened core face does not form a polymerized matrix surface at the same time as the flattened surface, as the payload core (10) transits the fluid channel surface (122) polymerization tails tend to form, contributing to a weak spot in the encapsulating membrane matrix as well as not having the desired spherical shape in the final product. Density of either the payload core and/or the encapsulation matrix can be altered by diluting out the fluid or by adding, for example, soluble solids, including, for example, sugar. In certain embodiments, a payload core can be cooler than the encapsulating matrix, wherein the density in the core is slightly greater than the matrix, to enhance translation into and through the fluid polymerizing matrix. Additionally, higher temperature of a matrix may enhance polymerization rates of the encapsulating membrane matrix. It is also noted that certain encapsulating membrane matrix fluids (120) have surface tensions and frictional forces which can be overcome by added components in the payload core having minimal effect on the core density, including, but not limited to, surfactants. In some embodiments, surfactants are added to the core to contribute to increase translation through the surface of the fluid encapsulating membrane matrix.

Various encapsulating membrane matrix materials are contemplated for use for the system embodiments. Such materials may vary in viscosity and/or density, for example as a function of temperature, as a function of concentration, etc. Therefore, both relative viscosity and/or density of the encapsulating membrane matrix fluid (120) to the core material payload (10) can be matched to influence the final encapsulated product shape. For example, if a core payload (10) viscosity is higher relative to the viscosity of the encapsulating membrane matrix fluid (120), the higher viscosity core material payload may tend to form a tear drop shape with a flattened leading face. If a core payload (10) viscosity is lower relative to the viscosity of the encapsulating membrane matrix fluid (120), the lower viscosity core material payload may tend to form a tear drop shape.

Additional considerations for optimizing viscosities and or densities of the fluid (120) and payload (10) include the overall effect on rate of translation of the core (10) through the matrix fluid (120) in conjunction with the rate of extrusion of core material (10) onto the fluid surface (122). If the timing of extrusion is constant, but core (10) density rises and/or fluid (120) viscosity falls, the products may tend towards a higher velocity translation through the payload channel (110) resulting in the core products contacting another and sticking together prior to sufficient polymerization of the matrix.

The previous description is provided to enable any person skilled in the art to practice the various aspects described herein. While the foregoing has described what are considered to be the best mode and/or other examples, it is understood that various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the terms “a set” and “some” refer to one or more. Pronouns in the masculine (e.g., his) include the feminine and neuter gender (e.g., her and its) and vice versa. Headings and subheadings, if any, are used for convenience only and do not limit the invention.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such an embodiment may refer to one or more embodiments and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

### EXAMPLE 1

### Density Ratio of Liquid Core/Liquid Matrix

Encapsulated products and parameters for making are presented, comprising a fluid core encapsulated in an alginate membrane using the machines and systems described herein. Methods and machines as presented result in substantially spherical final products wherein the product as a whole does not demonstrate significantly flattened faces or oblong shapes, and the encapsulating matrix does not substantially result in tail (teardrop) formation.

Encapsulated product shape characteristics were identified by instituting an experimentation protocol in which certain parameters expected to influence spherical product formation were varied. The viscosity of sodium alginate varies greatly based on the source, and percentages examined here are specific to low viscosity sources such as Danisco FD-150 and AIC SALMUP. However, alginates will have an upper limit of practicality for use in the processes described herein, as the viscosity for any alginate can become so great that real-time production flow will not occur at practical flow rates. For the processes and systems described herein, practical concentration limits for low viscosity alginates can be about 0.1% to about 4%. Therefore, viscosity of the encapsulating membrane matrix fluid (120) was varied using final concentrations of about 0.75%, about 1.5% and about 3% sodium alginate (Danisco: FD-150 or AIC: SALMUP). A base recipe for the core payload was made to a final density of between about 22 and 25 Brix (evaluated with an HI9608 Refractomer by Hanna, Inc.), and consisted of an aqueous mixture of about 18% cranberry concentrate and about 82% water, to which was added about 13 grams of cane sugar, and about 3.0 grams of calcium lactate per 100 grams of aqueous mixture. Viscosity in each core payload (10) was then varied by adding xanthan gum (TIC Gums: Pre-Hydrated Ticaxan Rapid-3 Powder) to final concentrations of between about 0.2-0.8%. Materials were then set aside overnight in a standard refrigerator and/or optionally de-gassed with a vacuum apparatus until stable density and viscosity values were achieved. Materials were analyzed for density (by independently evaluating payload and encapsulating matrix component weight per unit volume with standard laboratory equipment) and viscosity (determined with a Brookfield RVDV-II+ Pro Extra), and combinations of these variable parameters were tested on the system of the invention described herein to determine what ranges work together to make spherical product (Table 1). All samples were analyzed at room temperature, approximately 25 C.

TABLE 1
Physical values of encapsulated liquid core product ingredients.

| | | | | | | | | | | | Core:matrix | |
|---|---|---|---|---|---|---|---|---|---|---|---|---|
| | | | | | Payload core | | | | | | ratio | |
| % | Encapsulating Matrix | | | | % | | | | | | Viscosity | |
| alginate | Viscosity | Spindle | Speed | Density | Xanthan | Viscosity | Spindle | Speed | Density | Brix | ratio | density |
| 0.75 | 51.6 | RV-02 | 100 | 996.0 | 0.25 | 133.9 | RV-02 | 100 | 1048 | 21.95 | 2.59 | 1.052 |
| 1.5 | 103.2 | RV-02 | 100 | 1005.5 | 0.4 | 259 | RV-02 | 100 | 1095.4 | 22.0 | 2.51 | 1.089 |
| 1.5 | 162 | RV-03 | 100 | 1002.0 | 0.6 | 655 | RV-03 | 100 | 1092.4 | 24.7 | 4.04 | 1.090 |
| 3.0 | 36 | RV-05 | 100 | 989.13 | 0.8 | 89.2 | RV-05 | 100 | 1077.13 | 21.8 | 2.48 | 1.089 |

To make a substantially spherical encapsulated liquid product, the densities of the payload core and the liquid encapsulation matrix are preferably within a range relative to each other. Importantly, these results indicate that a density ratio range exists irrespective of the liquid encapsulation matrix (alginate) concentrations and the density of the payload core. The density ratio of the payload core to the alginate encapsulating matrix is between about 1.01 to about 1.15, between about 1.05 to about 1.15, between about 1.02 to about 1.14, between about 1.03 to about 1.13, between about 1.04 to about 1.12, between about 1.04 to about 1.11, between about 1.04 to about 1.10, between about 1.05 to about 1.09. Generally, as the encapsulation matrix material density increases, the density of the payload core must also increase so that the payload core is heavy enough to break the surface tension of the encapsulation matrix material as well as translate through the encapsulation matrix material at the preferred velocity for sphere formation. While any polymerizing matrix fluid (120) and aqueous payload core (10) is contemplated for use in the system described herein, the alginate polymerized matrices encapsulating an aqueous fluid core examples are meant as non-limiting examples.

1. A method for producing a substantially spherical soft food product containing a fluid inner core payload that is encapsulated by a polymer, wherein the fluid inner core payload is submerged into an encapsulating polymer solution to encapsulate the fluid inner core payload, the improvement comprising, providing a fluid inner core payload and an encapsulating polymer solution, wherein the density of the fluid inner core payload is about 1.05 to about 1.15 times the density of the encapsulating polymer solution.

2. A method for the production of a substantially spherical soft food product, comprising the steps of:
providing a fluid inner core payload and a fluid encapsulating polymer, wherein said fluid inner core payload density is about 1.05 to about 1.15 times the density of the fluid encapsulating polymer; and
submerging the fluid inner core payload in the fluid encapsulating polymer, wherein submerging further comprises the fluid inner core traversing through the fluid encapsulating polymer a distance sufficient for the fluid inner core payload to achieve a substantially spherical form.

3. A method for producing a substantially spherical soft food product containing an inner core payload that is encapsulated by a polymer, comprising
providing a fluid inner core payload and a payload channel containing an encapsulating polymer solution, wherein the density of the fluid inner core payload is about 1.05 to about 1.15 times the density of the encapsulating polymer solution; and
adding the fluid inner core payload to the payload channel of encapsulating polymer solution, wherein the fluid inner core payload traverses the payload channel of encapsulating polymer, wherein the substantially spherical soft food product is produced.

4. The method of claim 1, wherein said method is performed with the device shown in FIG. 1.

5. The method of claim 1, further comprising the step of polymerizing said fluid encapsulating polymer.

6. The method of claim 1, wherein said fluid inner core comprises cranberry juice or cranberry juice concentrate.

7. The method of claim 1, wherein said fluid inner core further comprises calcium.

8. The method of claim 1, wherein said encapsulating polymer comprises alginate.

9. The method of claim 1, wherein said inner core payload further comprises a soluble solid.
